(19) United States
(12) Patent Application Publication
(10) Pub. No.: US 2016/0171452 A1
(43) Pub. Date: Jun. 16, 2016

(54) Automated Consecutive Scheduling

(71) Applicant: Michael Brown, Brentwood, CA (US)

(72) Inventor: Michael Brown, Brentwood, CA (US)

(21) Appl. No.: 14/567,228

(22) Filed: Dec. 11, 2014

(51) Int. Cl. G06Q 10/10

(52) U.S. Cl. CPC G06Q 10/1095

(57) ABSTRACT

Techniques are described for automatically generating proposed meeting schedules. Each proposed meeting schedule can include a sequence of meetings that are scheduled sequentially such that the meetings are scheduled back to back. In one example, the proposed meeting schedule can be for an interested party and thus the interested party is a participant of each meeting in the meeting schedule. The techniques can include retrieving availability data from an exchange server and processing the availability data along with provided constraints to generate proposed meeting schedules which may work for all attendees.

### BACKGROUND

Business organizations grow over time through the hiring of new employees. During the hiring process, candidates are typically interviewed for an open requisition within the business organization. The interview process can be broken down into multiple steps including screening, interviews, and reference checks. Each step of the interview process can be the responsibility of a different employee within the business organization.

Multiple employees within the organization can interview a candidate to determine whether the candidate should be hired. Typically, the candidate visits the offices of the business organization and stays for a series of sequential interviews. However, each employee within the organization can have other meetings that they need to attend. Moreover, the candidate availability can also vary depending on the candidate. As a result, it can be difficult to find a time which is convenient for both the candidate and all the interviewees to conduct the series of interviews.

### SUMMARY

In one embodiment, a computer-implemented method receives, by a processor, a request to schedule a sequence of interviews with a candidate, the request including a desired time range to schedule the sequence of interviews. The method then identifies, by the processor, a desired list of interviewers to interview the candidate. The method then transmits, by the processor, a query to an exchange server to retrieve availability data associated with the desired list of interviewers. The method then receives, by the processor, the availability data from the exchange server. The method then generates, by the processor, a proposed interview schedule based on the availability data and the desired time range, wherein the proposed interview schedule includes the sequence of interviews that occur within the desired time range with a plurality of interviewers from the desired list of interviewers.

In one example, the availability data includes calendar data describing an appointment or a meeting that is associated with an interviewer.

In another example, the request further includes a location parameter configured to specify a location to conduct the sequence of interviews and generating the proposed interview schedule comprises filtering, by the processor, the availability data according to the location parameter and analyzing, by the processor, the filtered availability data to schedule the sequence of interviews.

In another example, the method further includes generating, by the processor, a second proposed interview schedule based on the availability data and the specified time range receiving, by the processor, a candidate desired time range, and ranking, by the processor, the proposed interview schedule and the second proposed interview schedule according to the candidate desired time range.

In another example, the request further includes a desired ordering for the desired list of interviewers and wherein generating the proposed interview schedule comprises scheduling, by the processor, the sequence of interviews to satisfy the desired ordering.

In another example, generating the proposed interview schedule comprises identifying, by the processor, the availability of an interviewer from the desired list of interviewers, determining, by the processor, that the interviewer is the least available of the desired list of interviewers, and scheduling, by the processor, the interviewer into the proposed interview schedule before another interviewer based on the determination.

In another embodiment, a non-transitory computer readable storage medium stores one or more programs comprising instructions for receiving a request to schedule a sequence of interviews with a candidate, the request including a desired time range to schedule the sequence of interviews, identifying a desired list of interviewers to interview the candidate, transmitting a query to an exchange server to retrieve availability data associated with the desired list of interviewers, receiving the availability data from the exchange server, and generating a proposed interview schedule based on the availability data and the desired time range, wherein the proposed interview schedule includes the sequence of interviews that occur within the desired time range with a plurality of interviewers from the desired list of interviewers.

In another embodiment, a computer implemented system comprises one or more computer processors and a non-transitory computer-readable storage medium. The non-transitory computer-readable storage medium comprises instructions, that when executed, control the one or more computer processors to be configured for receiving a request to schedule a sequence of interviews with a candidate, the request including a desired time range to schedule the sequence of interviews, identifying a desired list of interviewers to interview the candidate, transmitting a query to an exchange server to retrieve availability data associated with the desired list of interviewers, receiving the availability data from the exchange server, and generating a proposed interview schedule based on the availability data and the desired time range, wherein the proposed interview schedule includes the sequence of interviews that occur within the desired time range with a plurality of interviewers from the desired list of interviewers.

The following detailed description and accompanying drawings provide a better understanding of the nature and advantages of the present disclosure.

### BRIEF DESCRIPTION OF THE DRAWINGS

FIG. 1 illustrates a system for generating meeting schedules according to one embodiment;

FIG. 2 illustrates a system for generating a proposed meeting schedules according to one embodiment;

FIG. 3 illustrates a system for generating a proposed interview schedule according to one embodiment;

FIG. 4 illustrates a technique for generating a proposed interview schedule according to one embodiment;

FIG. 5 illustrates an interview scheduling page according to one embodiment;

FIG. 6 illustrates a process for scrolling through a collection of ordered items according to one embodiment;

FIG. 7 illustrates an exemplary computer system according to one embodiment.

### DETAILED DESCRIPTION

In the following description, for purposes of explanation, numerous examples and specific details are set forth in order to provide a thorough understanding of the present disclosure. It will be evident, however, to one skilled in the art that the present disclosure as expressed in the claims may include some or all of the features in these examples alone or in combination with other features described below, and may further include modifications and equivalents of the features and concepts described herein.

Described herein are techniques for generating one or more meeting schedules. Each meeting schedule can comprise of a sequence of meetings that each have at least one person in common. For example, a meeting schedule can be for interviewing a candidate where each meeting in the meeting schedule is a job interview meeting between the candidate and an interviewer and thus the sequence of meetings all include the candidate as an attendee of the meetings. The techniques described here analyze availability data related belonging to multiple interviewers and propose one or more meeting schedules that may work for the interviewers and/or the candidate. In some examples, a desired list of interviewers can include required interviewers and optional interviewers. The techniques described here can apply best efforts to generate meeting schedules that include the required interviewers.

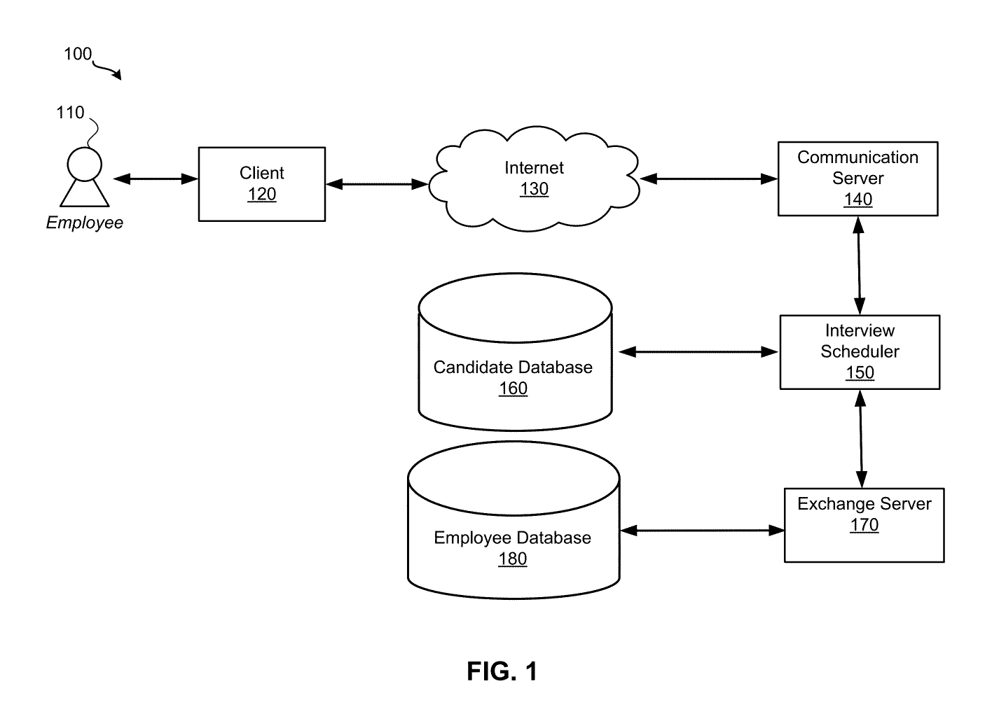

FIG. 1 illustrates a system for generating meeting schedules according to one embodiment. System 100 includes client 120 which is operated by employee 110. Client 120 can be a terminal which can be utilized by employee 110. Client 120 (along with other clients) can make up the frontend. System 100 further includes communication server 140. Communication server 140 is configured to communicate with client 120 (and multiple other clients) through internet 130. Communications received from the clients can be routed to interview scheduler 150 which is configured to generate meeting schedules. Each meeting schedule can include a sequence of meetings which all include a person of interest. In one example, the person of interest can be an employee within the organization. For instance, the person of interest can be an employee from human resources who wishes to set up a meeting with members within a group. The meeting schedule would be a sequence of meetings for the employee where each meeting is with a member of the group. In another example, the person of interest can be someone external from the organization. For instance, the person of interest can be a candidate who is interviewing for a position within the organization. The meeting schedule would be between interviewers and the candidate. The ordering and timing for the meeting schedule can be based on the schedules of the interviewers and optionally the schedule of the candidates. In another instance, the person of interest can be an auditor who is auditing the organization. The meeting schedule can be based on the schedules of the people who the auditor is auditing and the auditor's availability. In this embodiment, the person of interest is a candidate for a position within the organization and the sequence of meetings are between interviewers and the candidate. Interview scheduler 150 can query candidate database 160 to determine the availability of the candidate and generate a proposed meeting schedule that accommodates the schedules of both the candidate and the interviewers. Together, communication server 140, interview scheduler 150, and exchange server 170 make up the backend.

In some embodiments, interview scheduler 150 can attempt to generate a meeting schedule that can accommodate all parties involved. In some instances, the schedules of the parties involved may conflict thus preventing a solution from being found. In one embodiment, interview scheduler 150 can be configured to generate a proposed meeting schedule that requires the least amount of rescheduling for the parties involved. For example, interview scheduler 150 can generate a proposed meeting schedule that includes the minimum number of schedule conflicts for the interviewers involved. This can provide a best efforts solution.

System 100 further includes exchange server 170. Exchange server 170 can be configured to retrieve availability data of the interviewers. In one embodiment, the availability data can be retrieved from employee database 180. In one example, exchange server 170 can be an email and calendar server that is capable of managing both email and calendar events. In response to a query for calendar events associated with an employee, exchange server 170 can retrieve availability data associated with the employee. The availability data can include existing calendar events associated with the interviewer.

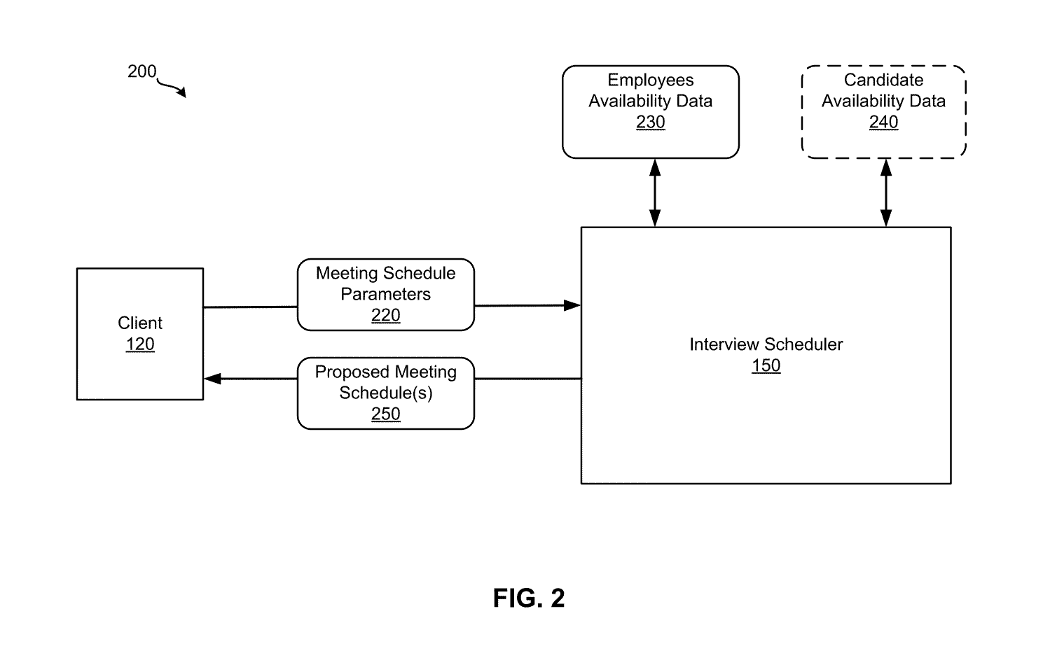

FIG. 2 illustrates a system for generating a proposed meeting schedules according to one embodiment. Client 120 transmits meeting schedule parameters 220 to interview scheduler 150. Meeting schedule parameters 220 can include parameters which confine the scheduling of the sequence of meetings in the meeting schedule. Examples of parameters can include a specified period of time in which the meeting schedule is to take place (e.g., schedule meetings for within the next week), a specified ordering of the parties who are to be attending the meetings (e.g., first have a meeting with party A, then followed by a meeting with party B), and/or a specified location to be hosting the meetings. Interview scheduler 150 receives meeting schedule parameters 220 and in turn, generates proposed meeting schedule(s) 250 which are transmitted back to client 120. In one embodiment, interview schedule 150 can retrieve employees availability data 230. The retrieved data can be used to dynamically generate a meeting schedule that complies with the meeting schedule parameters 220.

In some embodiments, interview scheduler 150 can also retrieve and process candidate availability data 240 while generating proposed meeting schedules 250. Candidate availability data 240 can provide additional information on the candidate. As described above, the candidate can be the party who is attending each meeting in the proposed meeting schedule. Candidate availability data 240 can include calendar data associated with the candidate. For instance, candidate availability data 240 can include data specifying that the candidate is unavailable from 2-3 pm on December 3. The candidate can be available due to an existing appointment or meeting during that period of time. In some examples, interview scheduler 150 can analyze the availability data of the candidate and the availability data of the employees to identify one or more time slots in which a sequence of meetings can be scheduled. Interview scheduler 150 can then select one of the identified time slots which do not violate any of the parameters of meeting scheduler parameters 220. For instance, a parameter from meeting schedule parameters 220 can specify that the meeting schedule take place within a specified period of time. Interview scheduler 150 can select an identified time slot that is within the specified period of time. Once a time slot has been selected, interview scheduler 150 can apply best efforts to schedule the sequential meetings based on a predefined ordering if one exists. The sequential meetings can then be stored as a proposed meeting schedule.

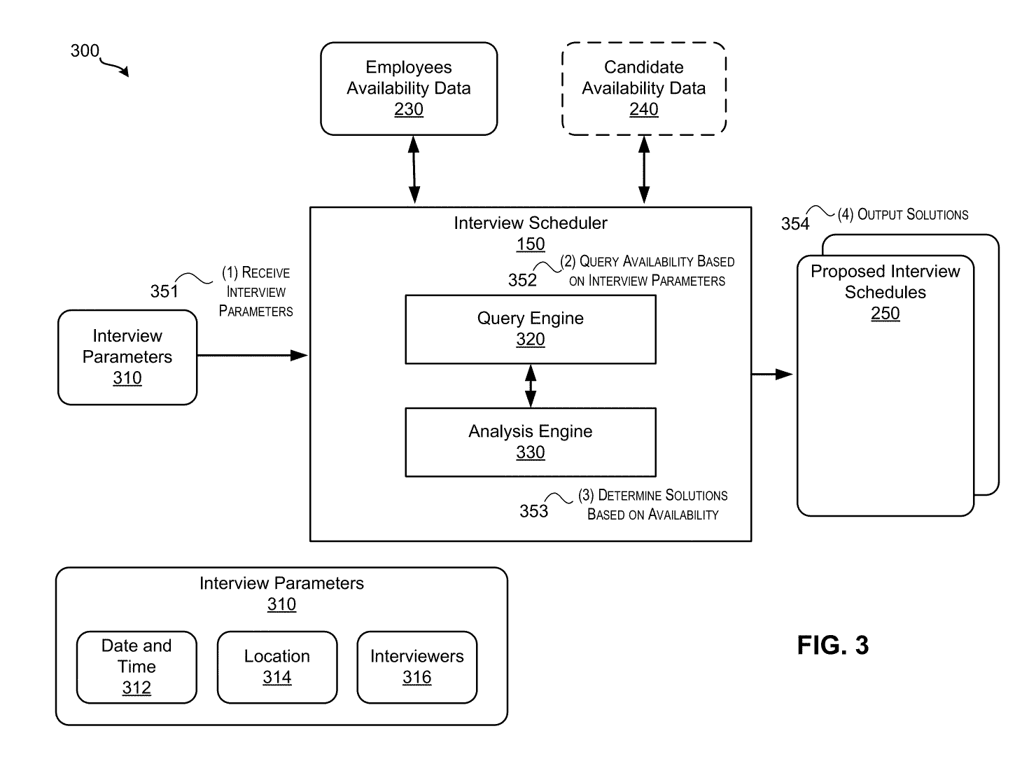

FIG. 3 illustrates a system for generating a proposed interview schedule according to one embodiment. As shown, system 300 includes interview scheduler 150, which includes query engine 320 and analysis engine 330. Initially, interview scheduler 150 can receive interview parameters 310 at step (1) (reference numeral 351). Interview scheduler 150 can perform different analysis based on the interview parameters received. In one embodiment, interview parameters 310 can include date and time parameters 312. Date and time parameters 312 can specify a time period which the interview schedule should take place.

Exemplary time periods can include the next week, the next month, or a period of time between a first date and a second date (e.g., February 5 to February 20). Interview scheduler 150 can generate an interview schedule that occurs during the specified time period. Date and time parameters 312 can also specify the duration allotted to the interview schedule. For example, date and time parameters 312 can specify that the interview schedule should take two hours. If the interviews are by default for 30 minutes, interview scheduler 150 can schedule four sequential interviews at 30 minutes each, thus totaling two hours.

In another embodiment, interview parameters 310 can include location parameter 314. Location parameter 314 can specify the location that the interviews in the interview schedule are to take place. Exemplary location parameters can include on-site, online, and over the phone. On-site interviews can include in person interviews where the candidate visits an office building that is hosting the organization. Online interviews can include interviews which occur online through video conferencing technologies. In some examples, interview scheduler 150 schedule interviews in a proposed interview schedule such that the interviews satisfy location parameter 314. For instance, interview scheduler 150 can filter through employees availability data 230 to identify availability data that satisfies location parameter 314. If location parameter 314 specifies that on-site interviews are desired, then employee availability data 230 that is associated with employees working from home may not be considered.

In another embodiment, interview parameters 310 can include interviewers list 316. Interviewers list 316 can specify a desired list of interviewers whom to include in proposed interview schedules 250. In one example, interviewers list 316 can include required interviewers and optional interviewers. Interview scheduler 150 can give priority to required interviewers over optional interviewers. In one example, interview scheduler 150 can first schedule the required interviewers and then schedule the optional interviewers to the remaining available meeting slots. In some situations, interviewers list 316 can set the list of interviewers in a preferred ordering. Interview scheduler 150 can identify a time slot in which the interviewers in interviewers list 316 can be scheduled in the preferred ordering. In some examples, interview scheduler 150 may be unable to propose an interview schedule based on the constraints in interview parameters 310. In this scenario, interview scheduler 150 can generate a warning to notify the user that an interview schedule could not be generated based on the given constraints.

Once interview parameters 310 have been received, interview scheduler 150 can query the availability of interviewers (and optionally the candidate) based on the interview parameters at step (2) (reference numeral 352). In one example, the queries can be performed by query engine 352. If a time period has been specified in date and time parameter 312, then interview scheduler 150 can query employees availability data 230 for employees who have free time during a portion of the time period. Similarly, interview scheduler 150 can optionally query candidate availability data 240 to determine whether the candidate is available during that time period. If location parameter 314 has been received, then interview scheduler 150 filter the availability data queried from employees availability data 230 for availability data which is associated with location parameter 314. For example if location parameter 314 is set to on-site, then query engine 320 can filter the availability data so that the results describe on-site availability and results related to online or on the phone can be filtered out. If interviewers list 316 has been specified, then query engine 320 can query employees availability data 230 for data on employees who are in interviewers list 316.

Once the availability data has been queried analysis engine 330 of interview scheduler 150 can determine solutions based on the availability data at step (3) (reference numeral 353). In one embodiment, different combinations of interviewers can be combined to see whether the combination results in a sequence of interviews which satisfy interview parameters 310. In another embodiment, analysis engine 330 can perform an algorithm to solve a traveling salesman problem. Once the solutions have been found, interview scheduler 150 can be configured to output the solutions at step (4) (reference numeral 354).

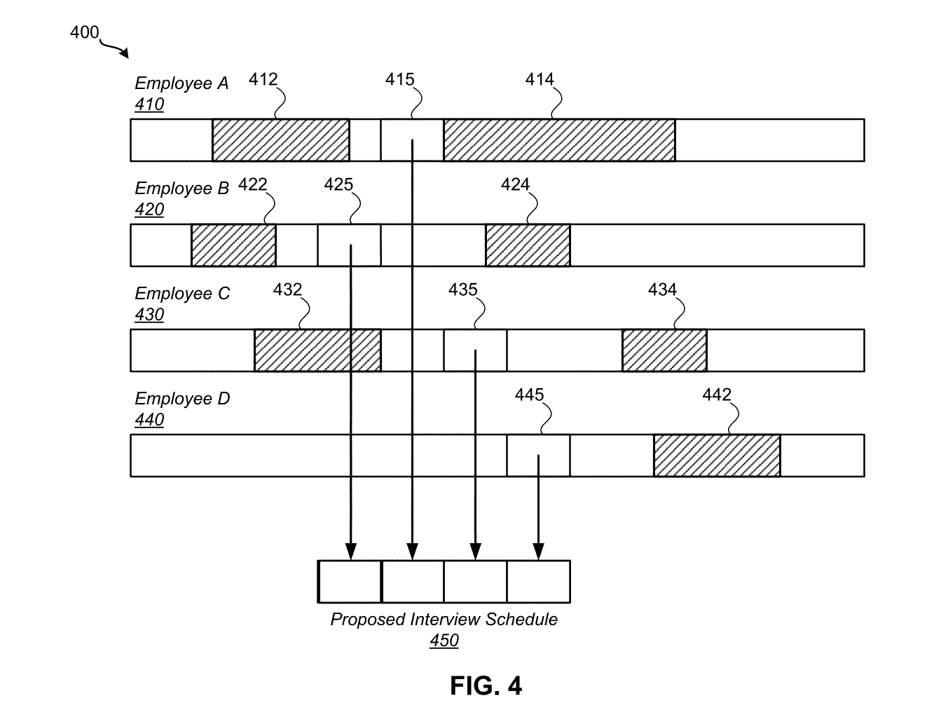

FIG. 4 illustrates a technique for generating a proposed interview schedule according to one embodiment. As shown, technique 400 includes four timelines that show the availability of four employees within the organization. Timeline 410 is associated with employee A, timeline 420 is associated with employee B, timeline 430 is associated with employee C, and timeline 440 is associated with employee D. Each timeline can illustrate the availability of a corresponding employee during a specified time frame. For example, timeline 410 illustrates that employee A is busy during time period 412 and time period 414 but is available during other periods of time within the specified time frame. Similarly, timeline 420 includes busy time periods 422 and 424, timeline 430 includes busy time period 432 and 434, and timeline 440 includes busy time period 442.

In one embodiment, the technique can analyze the busy time periods (or alternatively the available time periods) to generate proposed interview schedule 450 which consists of a list of sequential interviews. Sequential interviews are interviews where an interview ends as another interview starts. In other words, the interviews are scheduled back to back with minimal or no delay between interviews. This allows the organization to streamline the interview process, thus minimizing the time commitment required by the candidate.

Here, the technique can query the timelines to identify a block of time in which each employee has an available time slot that is adjacent to another employee. In one embodiment, the technique prioritize the handling of each employee based on the availability of the employee. For example, the technique can first analyze the timeline having the least amount of availability to identify time slots which the busy employee has available. Here, the busiest employee with the least amount of availability appears to be employee A. The technique can analyze an available time slot within timeline 410 to determine whether it is possible to schedule a block of time around the available time slot where the interviews are adjacent with one another in the block of time and the block of time includes the available time slot. Here, the technique can determine that at if employee A is scheduled for an interview with the candidate at time slot 415, a sequence of interviews can be scheduled for the other employees, thus creating a block of time that can represent the boundaries of proposed interview schedule 450. As shown here, proposed interview schedule 450 includes time slot 425 from timeline 420, time slot 415 from timeline 410, time slot 435 from timeline 430, and time slot 445 from timeline 440. The employee of timeline 430 also has availability for the period of time associated with time slot 445 and the employee of timeline 440 also has availability for the period of time associated with time slot 435. Thus, timeline 430 can optionally be scheduled as the fourth interview in the sequence of interviews and timeline 440 be scheduled as the third interview in the sequence of interviews.

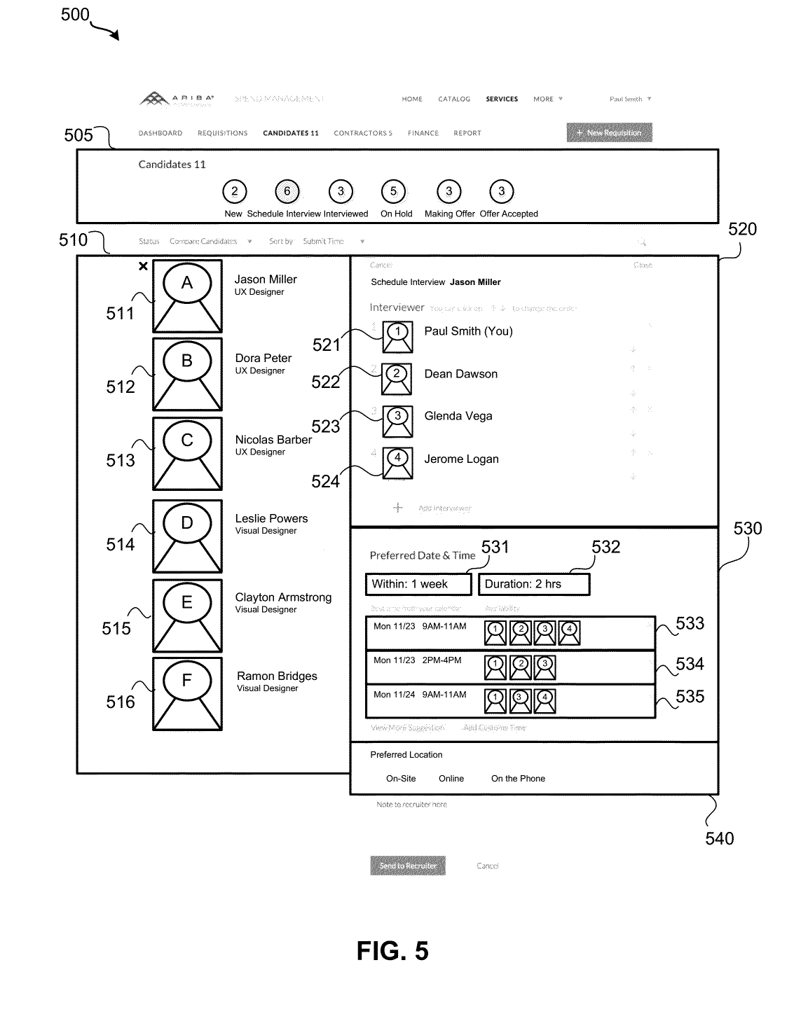

FIG. 5 illustrates an interview scheduling page according to one embodiment. Interview scheduling page 500 can be configured to assist a manager or other employee of the organization in scheduling interviews with candidates for an open requisition. Here, interview scheduling page 500 includes roadmap window 505, candidates window 510, interviewers window 520, proposed interview schedules window 530, and preferred location window 540. Roadmap window 505 is configured to display the number of candidates that are at each stage of the hiring process. The stage include new candidate, schedule interview, interviewed, on hold, making offer, and offer accepted. Each circle within roadmap 505 represents a stage and the number within the circle represents the number of candidates that are currently within the stage. In this example, interview scheduling page 500 is in the schedule interview stage and there are six candidates who are awaiting interview scheduling.

Candidates window 510 is configured to present a list of candidates who are applying for an open requisition. Here, candidates window 510 includes the six candidates; candidates 511-516. Each candidate is presented along with a profile picture that corresponds with the candidate. An indicator is positioned near candidate 511 to indicate that it is the selected candidate. This clarifies that interview scheduling is being performed for the selected candidate.

Interviewers window 520 is configured to present a desired list of interviewers to interview the selected candidate. Through a graphical user interface, interviewers can be added, removed, and repositioned within interviewers window 520. Here, interviewers window 520 includes interviewers 521-524. As a result, the interview scheduler can attempt to generate an interview schedule that includes the four interviewers in the specified order. In one embodiment, interviewers window 520 can include a switch that, when selected, sets the list of interviewers within interviewers window 520 as an ordered list. When the switch is unselected, the list of interviewers is an unordered list which can simplify the automated generation of the proposed interview schedule. For example, the interview scheduler may be able to generate additional proposed interview schedules when the interview list is unordered versus ordered.

Proposed interview schedules window 530 is configured to present proposed interview schedules. As shown, proposed interview schedules window 530 includes time period field 531 for specifying a time period in which to schedule the interviews. Here, time period field 531 has specified that the employee prefers to schedule the interview within the next week. Proposed interview schedules window 530 further includes duration field 532 for specifying a duration in which the interviews should be conducted. Here, the duration is set to two hours and there are four interviewers selected in interviewers window 520. The interview scheduler can divide the specified duration by the specified number of interviewers to generate a default duration for each interview. Here, the default duration for each interview is 30 minutes based on the two hour duration for the interviews and the number of interviewers being four. Interview scheduler can generate interview schedules based on the candidate, the list of interviewers, time period field 531, duration field 532, and/or other constraints. The generated interview schedules can be presented within proposed interview schedules window 530. Here, interview scheduler can generate interview schedules that contain three to four of the interviewers within the interview list. As shown, proposed interview schedule 533 includes all four interviewers while interview schedules 534 and 535 contain three of the four interviewers. All three include sequentially scheduled interviews and may be presented to the employee as proposals. The employee can use the proposals as a starting point for scheduling the interviews or for automatically scheduling the interviews.

In one embodiment, the interview scheduler can rank the proposed interview schedules based on the number of interviewers from the interview list that are included in the proposed interview schedule. Here, interview schedule 533 includes all four interviewers and thus is ranked higher than interview schedule 534 and 535 which include three of the four interviewers. In another embodiment, the interview scheduler can take into consideration the candidate's desired time range when ranking the proposed interview schedules. For example, the interview scheduler can receive as input the availability of the candidate. Based on the candidate's availability, the interview scheduler ran rank the proposed interview schedules such that interview schedules which do not conflict with the candidate's availability are ranked higher than interview schedules that do conflict with the candidate's availability. In on example, interview schedules that do conflict may still be presented since the interview schedule may be the only time which accommodates the interviewers. As a result, the employee may contact the candidate to see whether the candidate can reschedule the candidate's calendar to accommodate the proposed interview schedule.

In some embodiments, the employee can select a proposed interview schedule from proposed interview schedules window 530. The interview scheduler can generate an alert for a missing interviewer in the selected interview schedule. The alert can be provided to the missing interviewer in hopes that the missing interviewer can update his or her availability such that the missing interviewer can be added to the selected interview schedule. In one embodiment, the interview scheduler can provide to the missing interviewer one or more proposed time slots. The missing interviewer can review the proposed time slots and if possible, accept one of the proposed time slots. Upon receiving a response from the missing interviewer, the interview scheduler can update the selected interview schedule.

Location window 540 includes fields, which when selected, can provide further constraints to the proposed interview schedules. Location window 540 includes three selectable fields; an on-site field, online field, and on-the-phone field. Selecting one of these fields can provide a location constraint to the interviews. For example, selecting the online field can provide a constraint to the interview schedules that the interviews be conducted online By specifying the location of the interviews, the availability of the interviewers may change. In some embodiments, the interview scheduler can dynamically update the interview schedules presented within proposed interview schedules window 530 when a location field is selected.

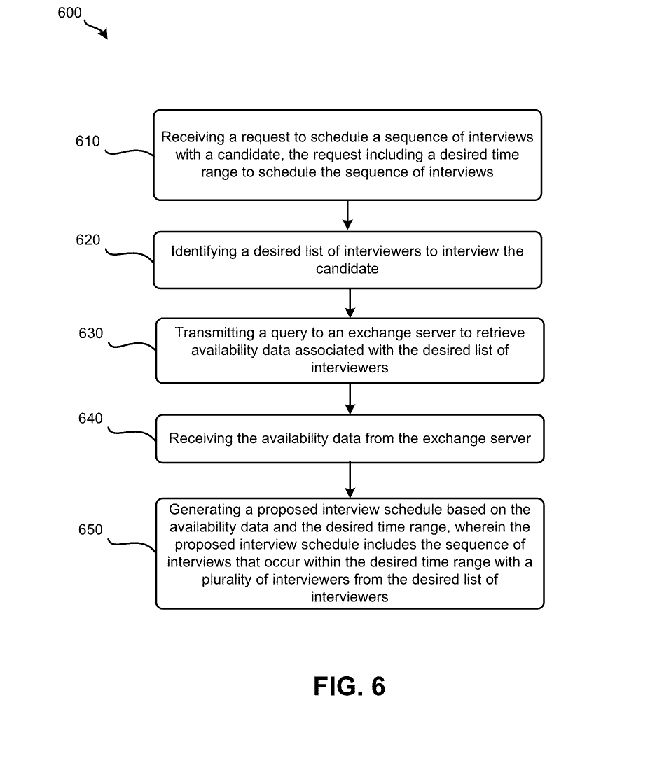

FIG. 6 illustrates a process for scrolling through a collection of ordered items according to one embodiment. Process 600 can be stored in computer readable code and executed by a processor. For example, process 600 can be part of the computer readable code that is part of interview scheduler 150 of FIG. 1. Process 600 can begin by receiving a request to schedule a sequence of interviews with a candidate, the request including a desired time range to schedule the sequence of interviews at 610. The desired time range can specify a period of time in which the interviews should be scheduled within. Exemplary time ranges can be a period of seven days starting from the current time or a period of time between November 5 and November 15. Process 600 can then continue by identifying a desired list of interviewers to interview the candidate at 620. The desired list of interviewers can include required interviewers and optional interviewers. Process 600 can prioritize the inclusion of required interviewers over optional interviewers in the interview schedule. In one embodiment, the desired list of interviewers can be received in the original request. In another embodiment, the desired list of interviewers can be generated based on the role or position that the candidate is applying for. For example, process 600 can query a look up table by submitting the position which the candidate is applying for an in response to the query, receive the desired list of interviewers. The look up table can map different positions to interviewers that conduct interviews for the position. The interviewers can be employees who belong to the group which the candidate would be joining or can be employees having experience interviewing for specific qualities or traits which are prerequisites for the position.

Process 600 can continue by transmitting a query to an exchange server to retrieve availability data associated with the desired list of interviewers at 630 and receiving the availability data from the exchange server at 640. In one embodiment, the query can include criteria specifying the interviewers whom availability data is being requested and also specifying the time period which the time range to fetch the availability data. For example, the query can include criteria specifying that availability data (such as calendar data) between the dates of November 5^{th} and November 15^{th} is being requested for employee A. The exchange server can process the query request and return the desired availability data.

Once the availability data is received, process 600 can continue by generating a proposed interview schedule based on the availability data and the desired time range at 650.

The proposed interview schedule can include the sequence of interviews that occur within the desired time range with a plurality of interviewers from the desired list of interviewers. In one embodiment, generating the proposed interview schedule can include identifying a segment of time within the desired time range that a majority of the desired list of interviewers have availability. Scheduling can then take place within the segment of time to try to schedule sequential interviews during the segment of time. If scheduling is successful, the interview schedule can be presented. If scheduling is unsuccessful, process 600 can identify a different segment of time within the desired time range and attempt to schedule the interviews within the different segment of time.

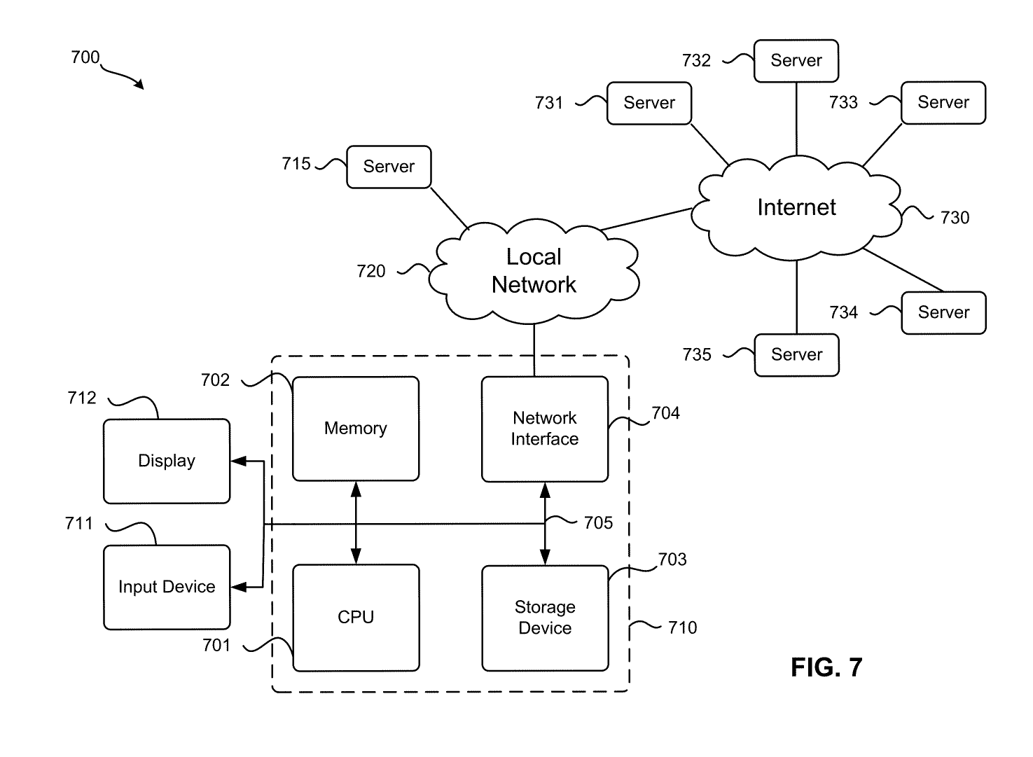

An exemplary computer system 700 is illustrated in FIG. 7. Computer system 710 includes a bus 705 or other communication mechanism for communicating information, and a processor 701 coupled with bus 705 for processing information. Computer system 710 also includes memory 702 coupled to bus 705 for storing information and instructions to be executed by processor 701, including information and instructions for performing the techniques described above, for example. This memory may also be used for storing variables or other intermediate information during execution of instructions to be executed by processor 701. Possible implementations of this memory may be, but are not limited to, random access memory (RAM), read only memory (ROM), or both. A storage device 703 is also provided for storing information and instructions. Common forms of storage devices include, for example, a hard drive, a magnetic disk, an optical disk, a CD-ROM, a DVD, a flash memory, a USB memory card, or any other medium from which a computer can read. Storage device 703 may include source code, binary code, or software files for performing the techniques above, for example. Storage device and memory are both examples of computer readable mediums.

Computer system 710 may be coupled via bus 705 to a display 712, such as a cathode ray tube (CRT) or liquid crystal display (LCD), for displaying information to a computer user. An input device 711 such as a keyboard and/or mouse is coupled to bus 705 for communicating information and command selections from the user to processor 701. The combination of these components allows the user to communicate with the system. In some systems, bus 705 may be divided into multiple specialized buses.

Computer system 710 also includes a network interface 704 coupled with bus 705. Network interface 704 may provide two-way data communication between computer system 710 and the local network 720. The network interface 704 may be a digital subscriber line (DSL) or a modem to provide data communication connection over a telephone line, for example. Another example of the network interface is a local area network (LAN) card to provide a data communication connection to a compatible LAN. Wireless links are another example. In any such implementation, network interface 704 sends and receives electrical, electromagnetic, or optical signals that carry digital data streams representing various types of information.

Computer system 710 can send and receive information, including messages or other interface actions, through the network interface 704 across a local network 720, an Intranet, or the Internet 730. For a local network, computer system 710 may communicate with a plurality of other computer machines, such as server 715. Accordingly, computer system 710 and server computer systems represented by server 715 may form a cloud computing network, which may be programmed with processes described herein. In the Internet example, software components or services may reside on multiple different computer systems 710 or servers 731-735 across the network. The processes described above may be implemented on one or more servers, for example. A server 731 may transmit actions or messages from one component, through Internet 730, local network 720, and network interface 704 to a component on computer system 710. The software components and processes described above may be implemented on any computer system and send and/or receive information across a network, for example.

The above description illustrates various embodiments of the present invention along with examples of how aspects of the present invention may be implemented. The above examples and embodiments should not be deemed to be the only embodiments, and are presented to illustrate the flexibility and advantages of the present invention as defined by the following claims. Based on the above disclosure and the following claims, other arrangements, embodiments, implementations and equivalents will be evident to those skilled in the art and may be employed without departing from the spirit and scope of the invention as defined by the claims.

What is claimed is:

1. A computer-implemented method, comprising:
receiving, by a processor, a request to schedule a sequence of interviews with a candidate, the request including a desired time range to schedule the sequence of interviews;
identifying, by the processor, a desired list of interviewers to interview the candidate;
transmitting, by the processor, a query to an exchange server to retrieve availability data associated with the desired list of interviewers;
receiving, by the processor, the availability data from the exchange server; and
generating, by the processor, a proposed interview schedule based on the availability data and the desired time range, wherein the proposed interview schedule includes the sequence of interviews that occur within the desired time range with a plurality of interviewers from the desired list of interviewers.

2. The computer-implemented method of claim 1, wherein the availability data includes calendar data describing an appointment or a meeting that is associated with an interviewer.

3. The computer-implemented method of claim 1, wherein the request further includes a location parameter configured to specify a location to conduct the sequence of interviews and generating the proposed interview schedule comprises:
filtering, by the processor, the availability data according to the location parameter; and
analyzing, by the processor, the filtered availability data to schedule the sequence of interviews.

4. The computer-implemented method of claim 1, further comprising:
generating, by the processor, a second proposed interview schedule based on the availability data and the specified time range;
receiving, by the processor, a candidate desired time range; and
ranking, by the processor, the proposed interview schedule and the second proposed interview schedule according to the candidate desired time range.

5. The computer-implemented method of claim 1, wherein the request further includes a desired ordering for the desired list of interviewers and wherein generating the proposed interview schedule comprises scheduling, by the processor, the sequence of interviews to satisfy the desired ordering.

6. The computer-implemented method of claim 1, wherein the proposed interview schedule includes an alert to an interviewer from the at least one of the plurality of interviewers to reschedule an existing activity that conflicts with the proposed interview schedule.

7. The computer-implemented method of claim 1, wherein generating the proposed interview schedule comprises:
identifying, by the processor, the availability of an interviewer from the desired list of interviewers;
determining, by the processor, that the interviewer is the least available of the desired list of interviewers; and
scheduling, by the processor, the interviewer into the proposed interview schedule before another interviewer based on the determination.

8. A non-transitory computer readable storage medium storing one or more programs, the one or more programs comprising instructions for:
receiving a request to schedule a sequence of interviews with a candidate, the request including a desired time range to schedule the sequence of interviews;
identifying a desired list of interviewers to interview the candidate;
transmitting a query to an exchange server to retrieve availability data associated with the desired list of interviewers;
receiving the availability data from the exchange server; and
generating a proposed interview schedule based on the availability data and the desired time range, wherein the proposed interview schedule includes the sequence of interviews that occur within the desired time range with a plurality of interviewers from the desired list of interviewers.

9. The non-transitory computer readable storage medium of claim 8, wherein the availability data includes calendar data describing an appointment or a meeting that is associated with an interviewer.

10. The non-transitory computer readable storage medium of claim 8, wherein the request further includes a location parameter configured to specify a location to conduct the sequence of interviews and generating the proposed interview schedule comprises:
filtering the availability data according to the location parameter; and
analyzing the filtered availability data to schedule the sequence of interviews.

11. The non-transitory computer readable storage medium of claim 8, further comprising:
generating a second proposed interview schedule based on the availability data and the specified time range;
receiving a candidate desired time range; and
ranking the proposed interview schedule and the second proposed interview schedule according to the candidate desired time range.

12. The non-transitory computer readable storage medium of claim 8, wherein the request further includes a desired ordering for the desired list of interviewers and wherein generating the proposed interview schedule comprises scheduling the sequence of interviews to satisfy the desired ordering.

13. The non-transitory computer readable storage medium of claim 8, wherein the proposed interview schedule includes an alert to an interviewer from the at least one of the plurality of interviewers to reschedule an existing activity that conflicts with the proposed interview schedule.

14. The non-transitory computer readable storage medium of claim 8, wherein generating the proposed interview schedule comprises:
identifying the availability of an interviewer from the desired list of interviewers;
determining that the interviewer is the least available of the desired list of interviewers; and
scheduling the interviewer into the proposed interview schedule before another interviewer based on the determination.

15. A computer implemented system, comprising:
receiving a request to schedule a sequence of interviews with a candidate, the request including a desired time range to schedule the sequence of interviews;
identifying a desired list of interviewers to interview the candidate;
transmitting a query to an exchange server to retrieve availability data associated with the desired list of interviewers;
receiving the availability data from the exchange server; and
generating a proposed interview schedule based on the availability data and the desired time range, wherein the proposed interview schedule includes the sequence of interviews that occur within the desired time range with a plurality of interviewers from the desired list of interviewers.

16. The computer implemented system of claim 15, wherein the request further includes a location parameter configured to specify a location to conduct the sequence of interviews and generating the proposed interview schedule comprises:
filtering the availability data according to the location parameter; and
analyzing the filtered availability data to schedule the sequence of interviews.

17. The computer implemented system of claim 15, further comprising:
generating a second proposed interview schedule based on the availability data and the specified time range;
receiving a candidate desired time range; and
ranking the proposed interview schedule and the second proposed interview schedule according to the candidate desired time range.

18. The computer implemented system of claim 15, further comprising:
wherein the request further includes a desired ordering for the desired list of interviewers and wherein generating the proposed interview schedule comprises scheduling the sequence of interviews to satisfy the desired ordering.

19. The computer implemented system of claim 15, wherein the proposed interview schedule includes an alert to an interviewer from the at least one of the plurality of interviewers to reschedule an existing activity that conflicts with the proposed interview schedule.

20. The computer implemented system of claim 15, wherein generating the proposed interview schedule comprises:
identifying the availability of an interviewer from the desired list of interviewers;
determining that the interviewer is the least available of the desired list of interviewers; and
scheduling the interviewer into the proposed interview schedule before another interviewer based on the determination.
